(19) United States
(12) Patent Application Publication
(10) Pub. No.: US 2013/0124366 A1
(43) Pub. Date: May 16, 2013

(54) APPARATUS AND METHODS FOR EFFICIENT GENERATION AND DELIVERY OF ITEM INFORMATION

(71) Applicants: Paul Breed, Solana Beach, CA (US); James Irish, San Diego, CA (US)

(72) Inventors: Paul Breed, Solana Beach, CA (US); James Irish, San Diego, CA (US)

(21) Appl. No.: 13/467,832

(22) Filed: May 9, 2012

Related U.S. Application Data
(60) Provisional application No. 61/484,163, filed on May 9, 2011.

(51) Int. Cl. G06Q 30/06

(52) U.S. Cl. CPC G06Q 30/0623
USPC 705/26.61

(57) ABSTRACT

Apparatus and methods for utilizing content from an item description source to enhance item quality information. In one exemplary embodiment, the information is pulled from an item advertisement in order to add value to an item quality report advertisement. In one variant, content from the item advertisement is utilized in an advertisement for an item quality information report. Providing this descriptive content pulled from the advertisement creates a connection for the customer between the item of interest and the item quality report. The descriptive information from the item advertisement may also be utilized to add value to the reports by incorporation therein as well. Providing the item description into an advertisement for an item quality report enables, among other things, the customer to validate that the description listed in the advertisement matches the description provided for that item from trusted item quality sources.

### PRIORITY AND RELATED APPLICATIONS

This application claims priority to co-owned, co-pending U.S. Provisional Application No. 61/484,163 filed on May 9, 2011 and entitled “APPARATUS AND METHODS FOR EFFICIENT GENERATION AND DELIVERY OF ITEM INFORMATION”, which is incorporated herein by reference in its entirety. This application is related to U.S. patent application Ser. No. 12/500,513 filed on Jul. 9, 2009 and entitled “APPARATUS AND METHODS FOR EFFICIENT DELIVERY OF AUCTION ITEM INFORMATION” which claims priority to U.S. Provisional Patent Application Ser. No. 61/134,655, filed on Jul. 10, 2008 and U.S. Provisional Patent Application Ser. No. 61/218,335, filed on Jun. 18, 2009 each of the same title and incorporated herein by reference in its entirety. This application is also related to U.S. patent application Ser. No. 13/007,837 filed on Jan. 17, 2011 and entitled “APPARATUS AND METHODS FOR GENERATION AND UTILIZATION OF SALES LEADS” which claims priority to U.S. Provisional Patent Application Ser. No. 61/303,209 filed on Feb. 10, 2010 of the same title, each of the foregoing incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates in one exemplary aspect to improved methods and apparatus for providing information regarding the history or other aspects of a purchasable item.

2. Description of Related Technology

Many vehicles, such as automobiles, boats, all terrain vehicles, motorcycles, sports vehicles, etc. come into the possession of auto dealers, financial institutions and/or other businesses and companies (hereinafter referred to collectively as “dealers”) after having, in some cases, at least one previous owner/user. Dealers may come into possession of used vehicles as a result of the vehicle lease agreement ending, as partial payment for a new vehicle (i.e., a trade in), as rental vehicles or fleet/company vehicles which have been cleared out to make room for newer vehicles, and as repossessed vehicles. Additionally, a private owner may seek to sell a vehicle as well.

Purchase of used vehicles requires research and diligence on the part of the buyer. In many instances, intimate knowledge about various types of motor vehicles would be required to identify a vehicle's potential mechanical problems. Often, there are problems or reasons not to purchase a vehicle which are not immediately obvious to a person merely viewing or test driving a used car. Likewise, a vehicle's market value may not be immediately apparent to a buyer.

Generally a party is able to determine vehicle history by using the vehicle identification number (VIN number) and one or more accessible vehicle information servers. For example, U.S. Pat. No. 7,778,841, to Bayer, et al. issued Aug. 17, 2010 and entitled “SYSTEM AND METHOD FOR GENERATING INFORMATION RELATING TO HISTORIES FOR A PLURALITY OF VEHICLES” which describes a system and method for generating information relating to a vehicle's history. In one embodiment, the method includes the steps of identifying target records in a database, determining a total number of owners for each vehicle based on the target records, and displaying a listing of the vehicles including corresponding number of owners. A step of determining and displaying the ownership type may be provided. A vehicle history information system is also provided, including a database having vehicle history records, a vehicle history report module adapted to retrieve the vehicle history record, an ownership module adapted to determine the number of owners for the vehicles based on the vehicle history records, and a user interface module adapted to generate a listing of the vehicles and the number of owners. The system may be adapted to determine and display the ownership type.

Determination of market and wholesale values of a vehicle may be accomplished in several ways, including via the potential purchaser accessing one or more consolidated vehicle valuation information servers. For example, U.S. Patent Publication No. 20080201163, to Barker, et al., published Aug. 21, 2008 and entitled “VEHICLE-VALUE ANALYZING AND MESSAGING SYSTEMS” discloses a system, process and computer software is disclosed for electronically accessing financial terms related to the acquisition of a vehicle by a purchaser, including contact information, original vehicle information, and the settlement amount. This system may electronically accesses used vehicle valuations, including an estimate for a vehicle similar to the vehicle included with the financial terms. The system may automatically correlate the financial terms to the used vehicle valuations. The system may determine the value-difference between the financial terms of the original vehicle and a new vehicle. The system may transmit a message to the purchaser to communicate that the purchaser can replace the original vehicle with a new vehicle.

However, despite the foregoing systems and methods, there is still a salient need for more efficient and reliable solutions for the delivery of vehicle information. Such improved techniques and apparatus would ideally be configured to increase revenue associated with sale of vehicle history reports by aggregating two or more types of useful information; e.g., displaying to customers an advertisement for a vehicle history report alongside recognizable vehicle description information (such as photos, text description, etc.). In this manner, the customer is able to draw a connection between the item of interest and the vehicle report product.

Ideally the improved techniques and apparatus would also be configured to enable the customer to identify inconsistencies in the seller's description of a vehicle, and make an informed purchase decision.

### SUMMARY OF THE INVENTION

In a first aspect of the invention, an apparatus for compiling information regarding an item for sale is disclosed. In one embodiment, the apparatus comprises at least one interface configured to receive information uniquely identifying the item for sale, and a digital processor configured to run software thereon. In one variant, the software comprises: (i) at least one application configured to use the uniquely identifying information to request item quality information from one or more trusted sources and create an item quality report therefrom, (ii) at least one application configured to use the uniquely identifying information to request item description information from one or more descriptive information sources, and (iii) at least one application configured to generate an advertisement relating to the item quality report, the advertisement incorporating the item description information.

In a second aspect of the invention, a method for providing information regarding an item for sale to a consumer is given. In one embodiment, the method comprises receiving information uniquely identifying the item for sale, collecting descriptive information about the item for sale from a plurality of descriptive information sources, displaying the descriptive information, collecting quality information about the item for sale from a plurality of item quality information sources, and providing a customer an opportunity to purchase the item quality information, the opportunity to purchase the item quality information featuring the display of the descriptive information.

In a third aspect of the invention, a server for collecting information regarding a plurality of items for sale is given. In one embodiment, the server comprises a first interface for communication to one or more partner servers, the partner servers providing searchable databases of items for sale, a storage entity, and a processor configured to run at least an application configured to query item quality information sources and generate an item quality report from data obtained therefrom, and at least an application configured to query and pool descriptive information received from a plurality of descriptive information sources. An advertisement for the item quality information report provided to one or more client devices may incorporate the descriptive information.

In a fourth aspect of the invention, one or more servers for collecting information regarding a plurality of items for sale are adapted to receive and compile information regarding an item for sale received from the various item information servers, including, inter alia, estimated resale servers, estimated wholesale servers, vehicle history servers and/or an auction servicer servers and to format the information into a formatted information report which is sent to the client device.

In fifth aspect of the invention, one or more servers for collecting information regarding a plurality of items for sale are adapted to, based on a vehicle identification number (VIN) received from a client, request, receive and compile reports received from various vehicle information servers and send the compiled information to the client in a format suitable for efficient transmission thereto. In one variant, the VIN is automatically obtained from an vehicle advertisement.

In a sixth aspect of the invention, a computer readable apparatus is disclosed. In one embodiment, the apparatus comprises a storage media adapted to store one or more computer programs which, when executed obtain and deliver item quality information and descriptive item information to a client device. In another embodiment, the computer program(s) obtain information from a partner website for use in obtaining subsequent quality information and for use in displaying to a client alongside an advertisement for the collected quality information.

### BRIEF DESCRIPTION OF THE DRAWINGS

FIG. 1 is a block diagram illustrating an exemplary embodiment of a report generating server for use with the present invention.

FIG. 1a is a block diagram illustrating an exemplary item information report generation system of the present invention.

FIG. 2 is a logical flow diagram illustrating an exemplary method of information collection and report generation for use with the present invention.

FIG. 2a is a logical flow diagram illustrating a detailed implementation of the method of FIG. 2.

FIG. 3a is a graphical representation of an exemplary interface for enabling a consumer to obtain an item information report.

FIG. 3b is a graphical representation of an exemplary interface for displaying to a customer the availability of an item information report.

FIG. 3c is a graphical representation of an exemplary interface for displaying to a customer the unavailability of an item information report.

FIG. 3d is a graphical representation of a second exemplary interface for enabling a customer to obtain an item information report.

FIG. 3e is a graphical representation of an exemplary interface for enabling a customer to enter billing information for the purchase of an item information report.

FIG. 3f is a graphical representation of an exemplary interface for enabling a customer to validate an item information report before a purchase thereof.

FIG. 3g is a graphical representation of an exemplary interface for providing additional information to a customer regarding information provided in an item information report.

All Figures © Copyright 2011-2012 MobileTrac, LLC. All rights reserved.

### DESCRIPTION OF THE INVENTION

Reference is now made to the drawings listed above, wherein like numerals refer to like parts throughout.

As used herein, the term “application” refers generally to a unit of executable software that implements theme-based functionality The themes of applications vary broadly across any number of disciplines and functions (such as e-commerce transactions, shipping transactions, entertainment, calculator, Internet access, etc.), and one application may have more than one theme. The unit of executable software generally runs in a predetermined environment; for example and without limitation, the unit could comprise a downloadable Java Xlet™ that runs within the JavaTV™ environment.

As used herein, the terms “client device,” “terminal,” “personal electronic device” (PED) and “user device” include, but are not limited to, personal computers (PCs), whether desktop, laptop, or otherwise, personal digital assistants (PDAs) such as the “Palm®” family of devices, cellular or “smart” phones such as the Apple iPhone, handheld computers, J2ME equipped devices, personal media devices, set-top boxes, or literally any other device capable of interchanging data with a network. Such devices may interface using wired or optical fiber mechanisms such as an IEEE Std. 802.3 Ethernet interface, Digital Subscriber Line (DSL), DOCSIS modem, hybrid fiber-coax (HFC) cable, FireWire (IEEE Std. 1394), Thunderbolt™, or alternatively via wireless mechanisms and protocols such as 3GPP/3GPP2, Bluetooth™, IrDA interface, IEEE Std. 802.11, UWB (e.g., IEEE-Std. 802.15 or similar), WiMAX (802.16), Wireless Application Protocol (WAP), GPRS, GSM, or any other of myriad data communication systems and protocols well known to those of skill in the communications arts.

As used herein, the term “computer program” is meant to include any sequence of human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

As used herein, the term “database” refers generally to one or more tangible or virtual data storage locations, which may or may not be physically co-located with each other or other system components.

As used herein, the term “digital processor” is meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, and application-specific integrated circuits (ASICs). Such digital processors may be contained on a single unitary IC die, or distributed across multiple components.

As used herein, the term “display” means any type of device adapted to display information, including without limitation CRTs, LCDs, TFTs, plasma displays, LEDs, and fluorescent devices.

As used herein, the term “memory” or “storage” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), and PSRAM.

As used herein, the term “network” refers generally to data or communications networks regardless of type, including without limitation, LANs, WANs, intranets, internets, the Internet, cable systems, telecommunications networks, satellite networks, and Virtual Private Networks (VPNs), or collections or combinations thereof, whether based on wired, wireless, or matter wave modalities. Such networks may utilize literally any physical architectures and topologies (e.g. ATM, IEEE-802.3, X.25, Token Ring, SONET, 3G/3GPP/UMTS, 802.11, 802.16, 802.15, Hybrid fiber-coax (HFC), etc.) and protocols (e.g., TCP/IP, HTTP, FTP, WAP, GPRS, RTP/RTCP, etc.).

As used herein, the term “speech recognition” refers to any methodology or technique by which human or other speech can be interpreted and converted to an electronic or data format or signals related thereto. It will be recognized that any number of different forms of spectral analysis (such as MFCC (Mel Frequency Cepstral Coefficients) or cochlea modeling, may be used. Phoneme/word recognition, if used, may be based on HMM (hidden Markov modeling), although other processes such as, without limitation, DTW (Dynamic Time Warping) or NNs (Neural Networks) may be used. Myriad speech recognition systems and algorithms are available, all considered within the scope of the invention disclosed herein.

As used herein, the term “vehicle” refers to any form of air, land or water transportation for either person, animals, and/or inanimate objects including, without limitation, buses, cars, sports utility vehicles, all terrain vehicles, motorcycles, boats etc,

### Overview—

The present invention relates in one aspect to methods and apparatus for utilizing content taken from a description information source to enhance item quality information. In one exemplary embodiment, the information is pulled from a webpage advertisement for selling a vehicle (such as an advertisement on eBay Motors®, CycleTrader®, AutoTrader®, CarMax®, etc.) in order to add value to an advertisement for a service selling a detailed report about the same item or vehicle. In one variant, content from the webpage advertisement for selling the vehicle may be utilized on an advertisement page encouraging consumers to purchase an item quality information report. Providing this descriptive content pulled from the advertisement page provides a “reiteration” of the vehicle that they have expressed an interest in, which therefore creates a connection in the customer's mind between the item of interest and the item quality report. The descriptive information from the webpage advertisement for selling the vehicle may also advantageously be incorporated into the item quality information report to add value thereto

In another embodiment, descriptive information from an item advertisement is collected for later use, in order to provide long term historical information about the item of concern.

There is a unique value in providing item descriptive information simultaneously with an advertisement for purchasing item quality information as discussed herein. Likewise, the single display of aggregated item quality information and item descriptive information to a user increases the value of both and provides a unique opportunity for a vehicle quality reporting service to both increase its total conversion rates (i.e., number of people who purchase an item quality report versus the number who see the page) as well as present a unique value to its consumers found in its reports.

Another attribute of pulling the seller's vehicle description (including photos, descriptive information, and/or VIN) into a webpage advertising an item quality report is that the customer may validate that the VIN and description listed in the advertisement match the description pulled for that VIN from item quality sources (including e.g., vehicle history server and government data providers). In this manner, the customer may directly compare the vehicle identification so as to correct or avoid any misleading or fraudulent claims regarding the make model year and odometer readings between the verified government records and the advertisement, without having to leave the order process (i.e., on a single page).

### Description of Exemplary Embodiments

It is noted that while the system and methods of the invention disclosed herein are described with respect to delivery of information regarding vehicles for sale over the Internet, certain aspects of the invention may be useful in other applications, including, without limitation, vehicle or other chattel auctions, private sales (i.e., sales between two parties which are not in the business of vehicle transactions), telephonic (i.e., non-Internet based) orders and sales, etc.

### Item Information Report Generation—

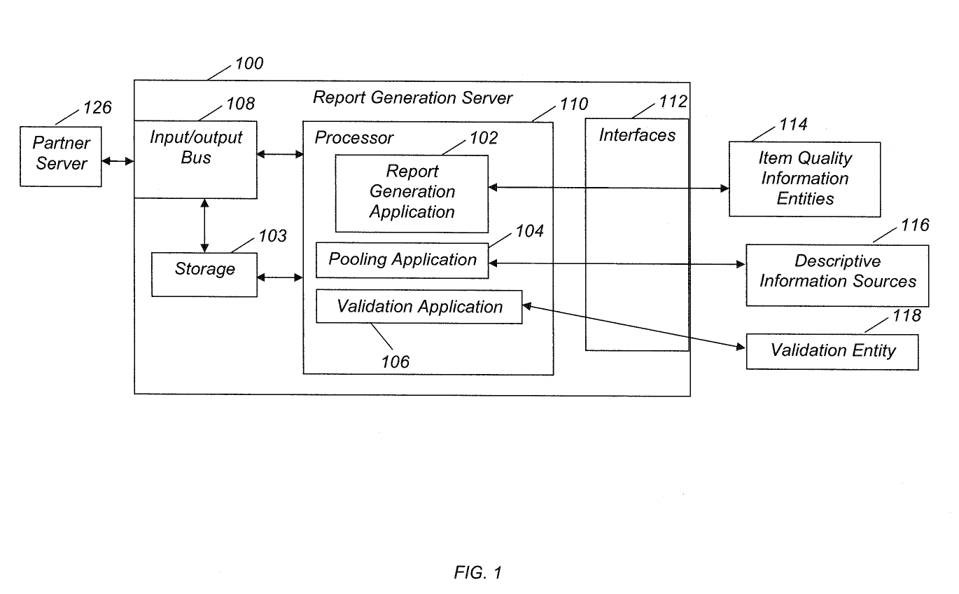

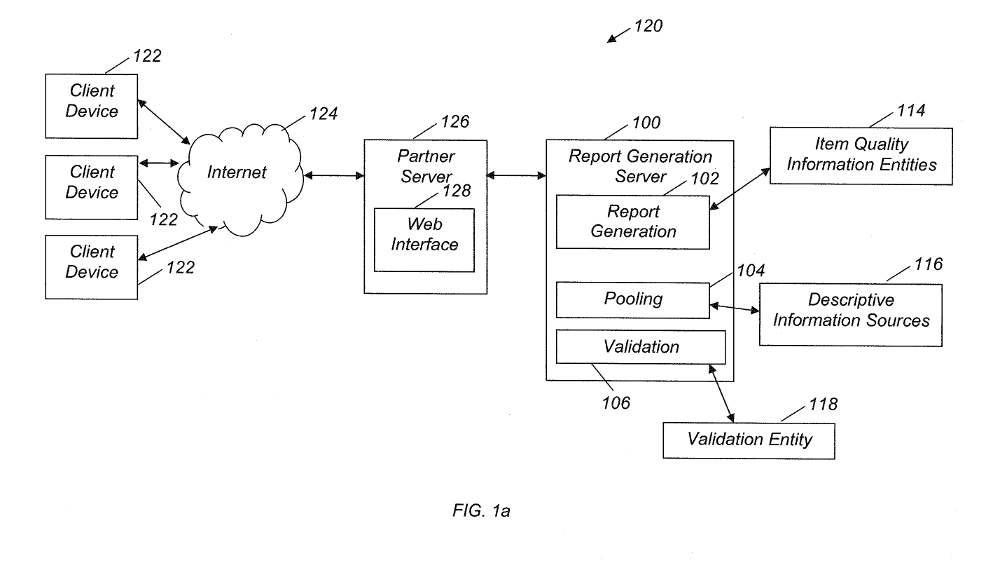

One salient feature of the present invention is the utilization of one or more report generation servers 100. An exemplary server 100 is illustrated in FIG. 1. As shown, the server 100 generally comprises an input/output bus 108, a storage device 103, a digital processor 110 and a plurality of interfaces 112 for connection to other devices via one or more networks.

The input/output bus 108 of the report generation server 100 is the subsystem for the transfer of data into and out of the server 100. For example, data in the form of a request for an item information report may be transferred into the server 100 from client devices (not shown) via intermediary partner server 126 for instance, running a website accessible to the client devices. Item information (such as in the form of a generated report) may be transferred out of the server 100 to the partner server 126, and then on to the requesting client devices.

In one variant, the item of concern comprises a vehicle such as a car, truck, motorcycle, van, sport utility vehicle (SUV), boat, recreation vehicle (RV), however, other items may be utilized in the system described herein as well. The request for an item information report may include information identifying the item of concern such as a vehicle identification number (VIN) in the instance the item of concern is a vehicle; alternatively other identifiers may be employed. The input/output bus 108 may be utilized for receiving at the server 100 additional information obtained from the partner server 126 including e.g., photos, descriptions, etc. of the item of concern.

In yet another embodiment, a shortened form of a VIN may be utilized as discussed in co-owned, co-pending U.S. patent application Ser. No. 12/500,513, previously incorporated herein by reference in its entirety.

The storage device 103 of the report generation server 100 is adapted to store processed and formatted item information. In one embodiment, as discussed above, the items may comprise vehicles and the processed and formatted item information may be stored according to VIN number.

As illustrated, the report generation server 100 further comprises a digital processor 110, running at least a report generation application 102, a pooling application 104, and a validation application 106 thereon. In one embodiment, the report generation application 102 is utilized to request and receive item quality information from a plurality of trusted item quality information entities 114 as well as format data received from the item quality information entities 114 into data which is more efficiently transmitted and more easily read by the client devices (not shown). Formatting may, in one embodiment, comprise summarizing and/or presenting only portions of the data received. Thus the system may provide a summary to the devices prior to purchase, alternatively, the purchased report may be of summarized format so as to be suitable (i.e., simple or small enough) for transmission to a client via text or other messaging in a timely and reliable manner. Alternatively or in conjunction, a formatted full report may be provided for email, http or other display.

Generally the information received from the item quality information entities 114 comprises verifiable, trusted information. For example, in the instance the item of concern is a vehicle (car, truck, motorcycle, etc.), information may be obtained from inter alia, estimated resale servers, estimated wholesale servers, auction item databases, auction servicer servers, estimated resale servers, vehicle history servers, government records and databases, etc. In many instances, information received from the aforementioned sources 114 may be relied upon as valid or trusted based on the representations of the source. In other words, the given sources 114 are provided specifically for generating and validating the given information.

The pooling application 104 is generally utilized to request and receive item information from descriptive information sources 116. Unlike the trusted item quality information entities 114 discussed above, the descriptive information sources 116 include unverifiable sources of information. For instance, information may be pulled from an advertisement for the item of concern, such as a photo or description. At least a portion of this information may also be received from the partner website 126 as well. Likewise, descriptive information may be gathered from the Internet, stored records for previous sales of the same item. The pooling application 104 pools and formats any descriptive information received from these sources 116 for display to the customer or operator of the client device via the partner website. As will be discussed in greater detail below, the pooled descriptive information and trusted quality information may be provided to the client device simultaneously on one or more display screens.

The validation application 106 is utilized to process and validate payment information. In one embodiment of the invention, the consumer is provided with a mechanism for purchasing a report generated by the report generation application 102. Purchase according to this embodiment occurs when the customer enters billing information (such as credit card number, name, billing address, etc.) at the partner website. The billing information is passed to the validation application 106 of the report generation server 100, which in turn passes it to a validation entity 118. The validation entity 118 returns a “valid/not valid” message to the application 106 which thereby validates the payment and causes the purchased report to be provided to the user device, or causes an invalid message to be provided thereto.

It is also appreciated that the methods of the present invention may be practiced using any configuration or combination of hardware, firmware, or software, and may be disposed within one or any number of different physical or logical entities. Myriad different configurations for practicing the invention will be recognized by those of ordinary skill in the network arts provided the present disclosure.

The report generating server 100 can also be masked or controlled by a “business rules engine” or other logical wrapper or layer. These rules may be fully integrated within various entities associated with the present invention, or may be controlled via e.g., the client device, the partner server 126, or another operator manage entity (not shown). In effect, the rules engine comprises a supervisory entity which monitors and selectively controls the item information acquisition and delivery functions at a higher level, so as to implement desired operational or business rules. The rules engine can be considered an overlay of sorts to the information management and delivery algorithms.

For example, one rule implemented by the rules engine may comprise providing alerts/reminders to certain classes of subscribers or users (e.g., those at a premium level of service, or subscribers who have “opted-in” to receiving the alerts/reminders).

Another rule might comprise providing access to additional information or features such as detailed research, information, access to law enforcement or manufacturers records, etc., for subscribers who sign up for a “premium” report or plan.

### Item Information Report System—

Referring now to FIG. 1a, an exemplary system for report generation is illustrated. As shown, the system generally comprises a plurality of client devices 122 in communication with a web interface 128 running on a partner server 126 via an internet 124 (e.g., the Internet). In one embodiment, a client device 122 searches the partner website and encounters an item of interest. The item of interest may, in one instance be a vehicle having a VIN. However, it is appreciated that the present invention may be utilized to gather information regarding other items, including those having other identifying features.

Although illustrated and discussed herein in terms of a web-based embodiment, it is appreciated that other mechanisms for the client device 122 to access the partner server 126 and/or the report generating server 100 directly may also be utilized with the present invention. For example, the devices 122 may utilize e.g., web-based instant messaging, SMS-based text messaging, email, telephonic responses, or other forms of communication.

As shown, in FIG. 1a, at a client device 122, the customer enters identification information (e.g., a VIN) into a web interface 128 associated with the partner server 126.

Although illustrated as utilizing the Internet 124, other networks may be utilized as well. For example, the device 122 may comprise a mobile device, which may utilize SMS text messaging to send a request for information to the partner server 126. In one variant, the methods and apparatus disclosed in the previously incorporated co-owned and co-pending U.S. patent application Ser. No. 12/500,513 may be utilized to provide SMS-based communications. As discussed therein, a server entity adapted to communicate with a plurality of information sources (such as sources having vehicle history information, estimated valuation information, etc.) such as the report generating server 100 compiles information received from the plurality of sources (such as e.g., the item quality information sources 114 and the descriptive information sources 116) and formats the information for efficient delivery to a client device via e.g., SMS based text messaging, internet-based instant messaging, or the like. The server entity (reporting server 100) may also calculate and communicate estimates and/or alerts/reminders of when bidding will begin for particular items for auction which the client has expressed interest in.

The partner interface 128 passes the identification information to the report generation server 100. The server 100 uses the identification information as part of a request message which is sent to any number of item quality information entities 114 and descriptive information sources 116.

In an exemplary implementation, the server 100 may request information from the following item quality information entities 114: (i) an estimated resale server, (ii) an estimated wholesale server, (iii) a vehicle history server, and/or (iv) one or more government entities. The queried entities 114 provide, in response to the request provide estimated value reports (EVR), the EVR may include an estimate of the amount a client may expect to be able to resale the item for, and/or an estimate of the amount a client may expect to pay wholesale for the item. Additionally, in the instance the item is a vehicle, the vehicle VIN may be used to retrieve a vehicle history report (VHR). The VHR may be requested from, inter alia, a department of motor vehicles, Autocheck™, CarFax™, or generated by any number of web-based servers such as, inter alia, isitalemon.com, eztitlesearch.com, ebay.com, cardectective.com, Gov-Reports.com, etc.

Likewise, the descriptive information sources 116 may be queried using the identification information (e.g., VIN) or other identifying information regarding the item. For instance, using the VIN, a source for determining previous sales of the vehicle may be queried; this may include e.g., a general query of the Internet. The descriptive information source 116 may further include the partner server 126. In other words, the pooling application 104 may query the partner server 126 for pictures and/or a description of the item for sale. Additionally, descriptive information such as photographs, detailed descriptions, etc. may be obtained from one or more insurance providers (such as photographs taken at the time the vehicle was insured and/or at the time of an accident, etc.).

The server 100 is adapted to receive and compile any reports received from the various item quality information servers 114 (including, inter alias EVR and/or VHR) as well as any information (including photos and item descriptions) from the descriptive information sources 116. Computer applications located on the server 100 (including one or more of the report generating server 102 and/or the pooling application 104) direct the formatting of the reported information into a form that is suitable for transmission to the client device. The formatting may include e.g., causing the information to be displayed as a single display to the device 122. In one embodiment, the formatted reports are duplicated, and one copy is sent for storage at a database (not shown).

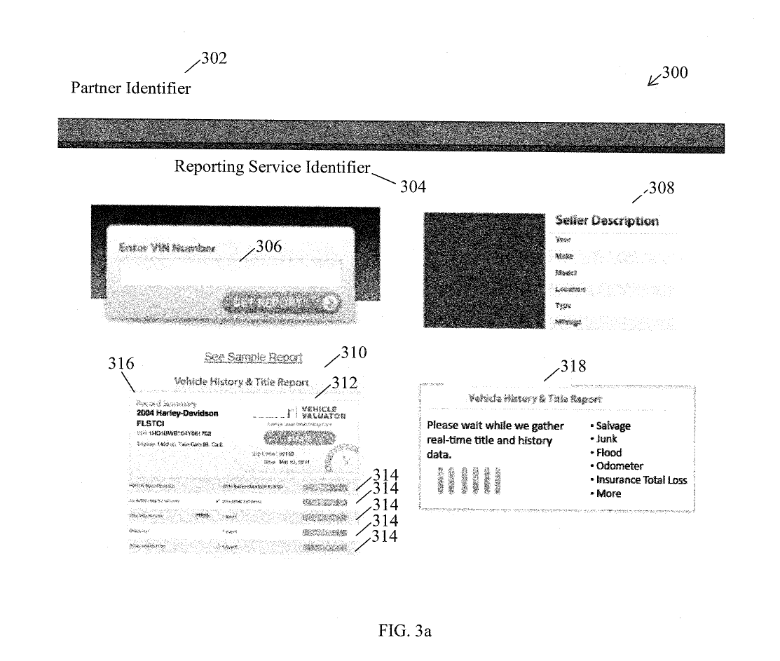

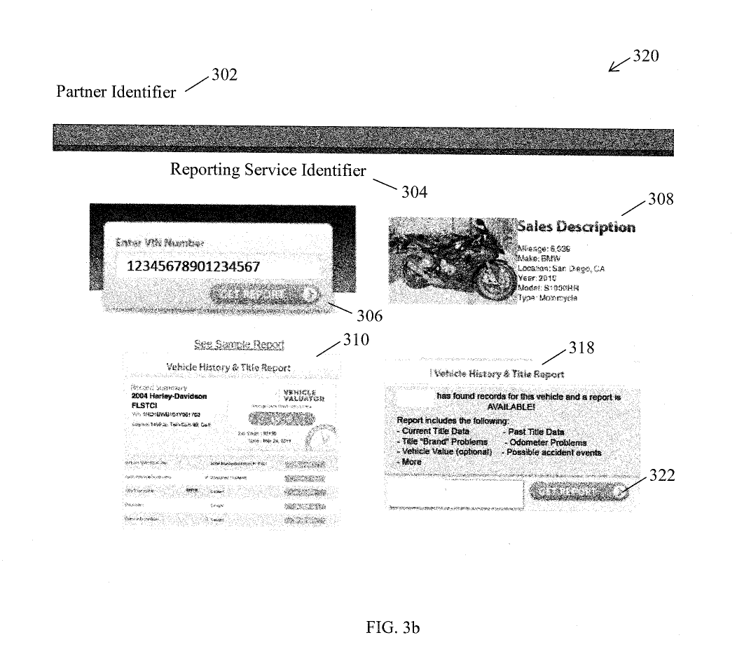

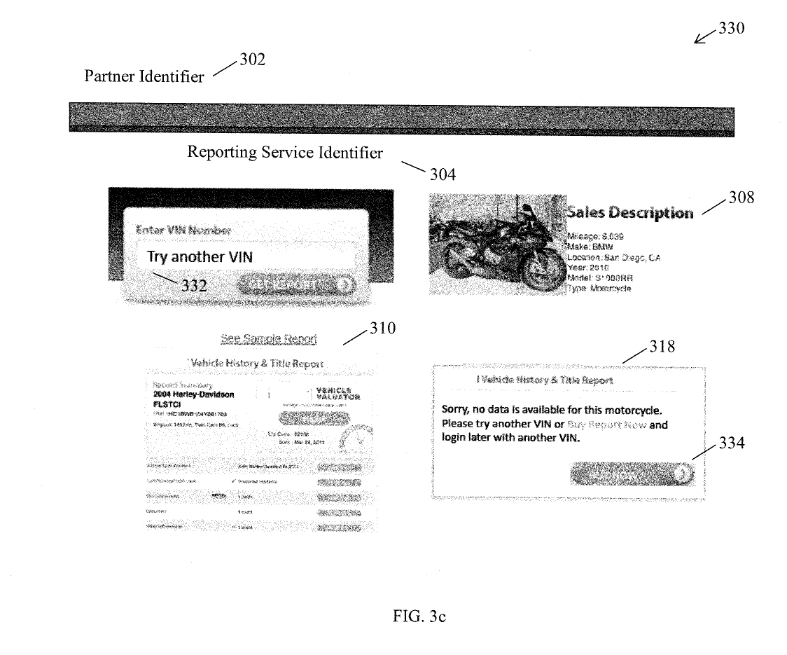

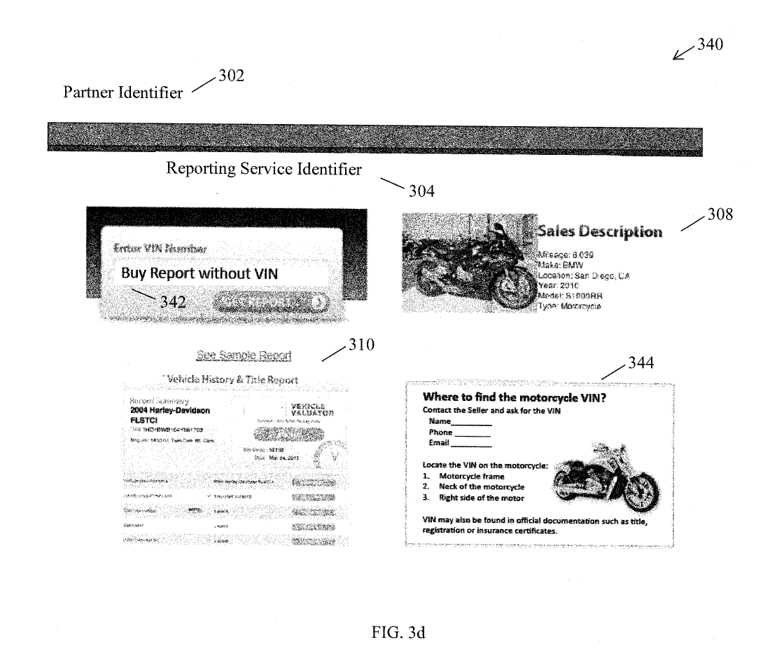

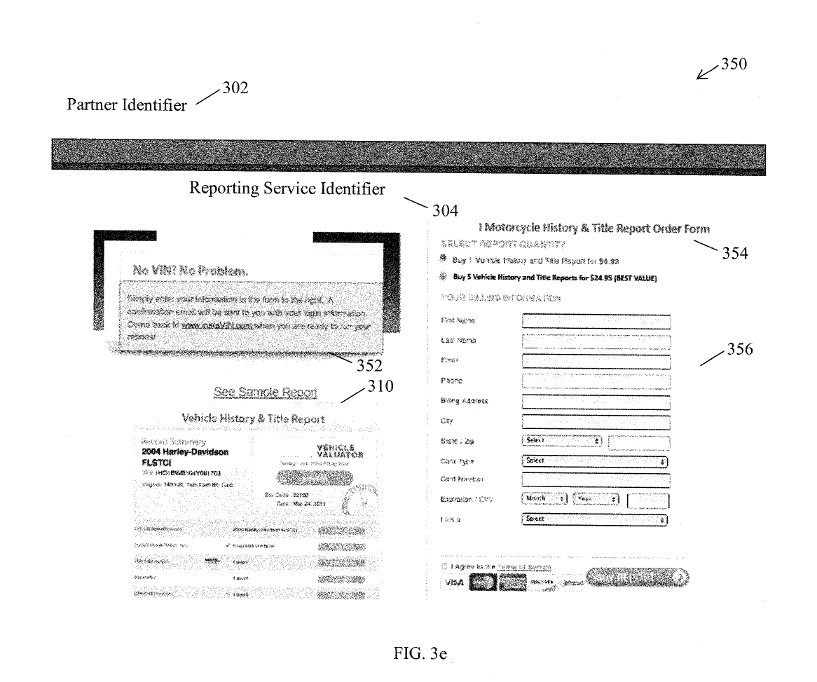

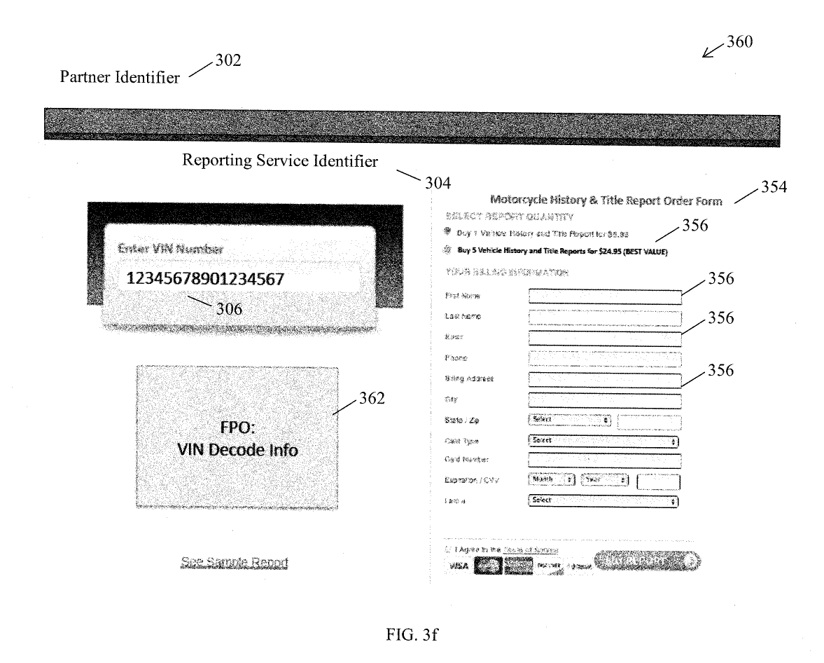

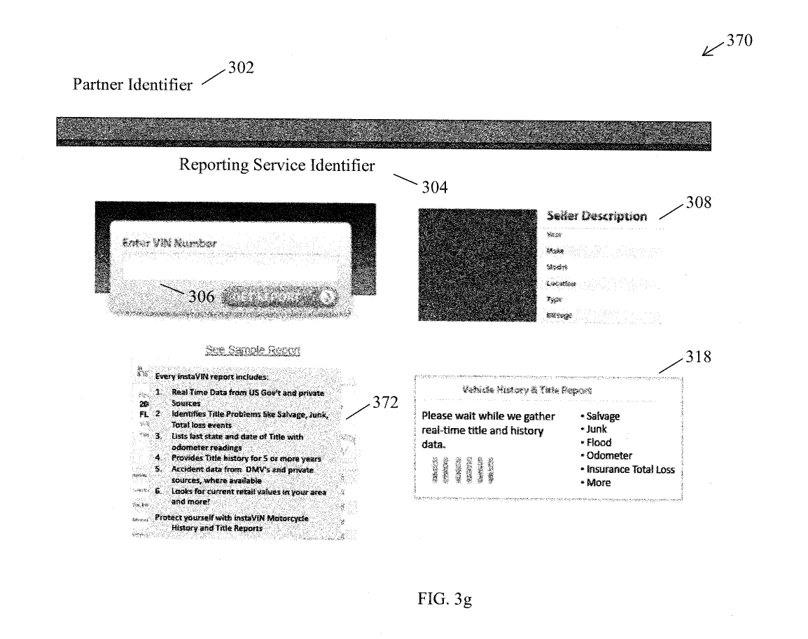

It is further appreciated that the pooling application 104 may be utilized to provide the descriptive information for display to the devices 122 throughout the report purchase process (as will be discussed with respect to FIGS. 3a-3g below). In this manner, the customer is constantly reminded of details of the item for sale, thus encouraging sale not only of the item but also of the detailed quality information and description report.

It is noted that delivery of the formatted report including information obtained from the item quality information sources 114 may be contingent upon payment of a fee. Accordingly, a validation application 106 is utilized to retrieve payment information entered by the customer at the web interface 128, and to provide the information to a validation entity 118. For instance, if the customer provides Visa card information, a server associated with Visa may be queried to ensure the billing information (including name, billing address, card number, etc.) is correct.

Once the purchase is confirmed/validated, the formatted report is provided to the requesting client device 122. In one embodiment, the formatted report includes information received from the item quality information sources 114, as well as the pooled information (photos and descriptions) from any descriptive sources 116 (including the Internet and the partner server 126).

In another embodiment, the client may, rather than inputting the VIN, instead use a camera function of the client device 122 to take a picture of the VIN, or may use OCR software and/or a scanner. The client device 122 will then utilize the optical character recognition program (such as GOCR, JOCR, etc.) to convert the pictured image to text, the text is then sent to the partner server 126 web interface 128 and forwarded on to the report generating server 100 as discussed above.

It is appreciated that other forms of VIN entry may also be utilized including e.g., speaking or saying the number into a client device 122 capable of recognizing and translating the speech to text. For instance, a speech recognition algorithm may be resident within the device 122, and in conjunction with a microphone, convert received analog signals from a user (e.g., a VIN) into a digital representation thereof, which is then used to query the sources as discussed above. Such speech recognition algorithms and systems are well known in the art, and accordingly not described further herein.

### Methodology—

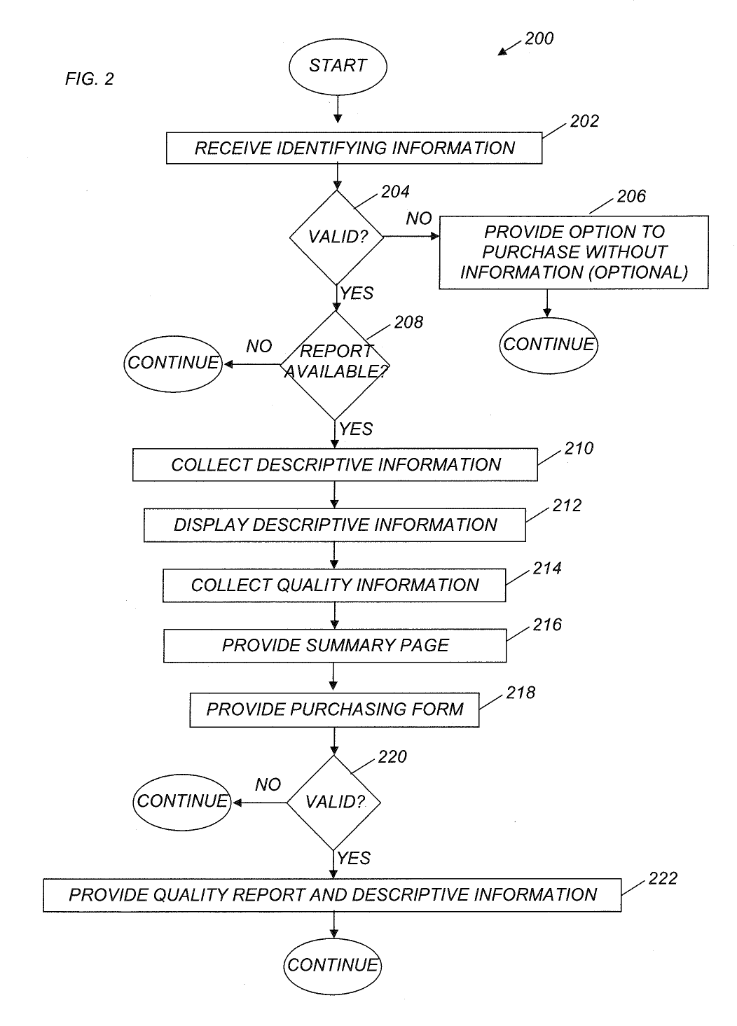

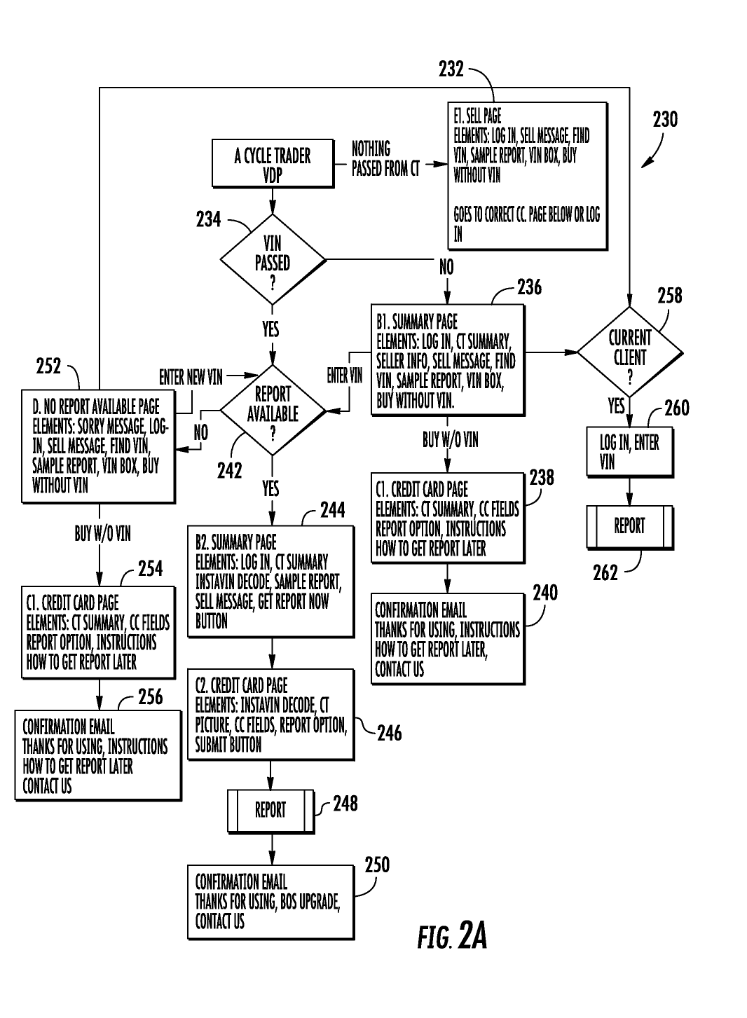

An exemplary method 200 of employing the report generating server 100 of the present invention is now described with respect to FIG. 2. In one embodiment, this method is performed to obtain item quality information and descriptive information at a client device 112.

As illustrated, at step 202, the report generating server 100 receives distinguishing information about the item(s) the customer is interested in obtaining information about, such as a VIN, or a picture of a VIN, an item number, etc. In one embodiment, the distinguishing information (VIN or the like) is sent from the client device 122 to the server 100 via the partner website 128. Then, per step 204, it is determined whether the entered identification information is valid. The validity of the VIN or other identifying information is determined in one implementation of the invention by comparing a decode of the entered VIN to information known about the item. For instance, if a decode of the entered VIN corresponds to a Volkswagen Jetta, whereas it is known from the partner website that the customer was interested in a BMW M3, then the entered VIN is invalid. Likewise, if the entered VIN cannot be correlated to any vehicles (at the item information sources 114), then the VIN is invalid.

In the instance identification information is not valid or the customer does not have identification information (such as a VIN), the customer may optionally be provided an option to purchase a report anyway (step 206). It is further appreciated that in the instance the entered identification information is not valid (in that it does not correspond to the description of the item provided at the partner website), the customer may be provided a message indicating the same. The customer may also be given alternatives such as options for purchasing a report for the actual item he/she is interested in without the identification information.

If the item identification information is valid, it is next determined whether an item report is available for the item (step 208). In one variant, the availability of a report may be determined by a preliminary query to one or more item information sources 114, merely to determine whether information regarding the item is available, without actually requesting the information therefrom. In another variant, the availability of a report may be determined based on whether a previous report for this same item has been generated and stored at the report generating server 100 or another storage entity in communication therewith (not shown).

Then, per step 210, descriptive information is collected from the plurality of descriptive information sources 116. The descriptive information is pooled and formatted for display (step 212) to the client device 122. In one embodiment, the descriptive information is pooled from e.g., the partner website 128 and other Internet sources. The descriptive information, once formatted, is displayed throughout the item quality report purchase process (as shown in FIGS. 3a-3g).

At step 214, quality information is collected from the plurality of item quality information sources 114. A request is sent from the server 100 to various item quality information servers 114, including for example, an estimated resale server, an estimated wholesale server, a vehicle history server, and/or an inspection information server. Per step 216, a summary of the item quality information may be generated and provided to the device 122 in order to encourage a purchase of the full report.

Next, at step 218, a purchasing form is provided to the customer. The purchasing form enables the customer to provide billing information to purchase the full report. The purchasing form may require entry of a billing name, billing address, credit card number, etc. The information entered into the purchasing form is validated at step 220. If the billing information is invalid, a message may be transmitted to the customer to re-enter the information. If the billing information is valid, the information received from the item quality information servers 114 and the descriptive information sources 116 is then compiled and formatted into a quality report suitable for transmission to the client (step 222).

An exemplary method 230 of employing the report generating server 100 of the present invention to obtain item quality information and descriptive information about a vehicle is illustrated in FIG. 2a. The method 230 comprises, when no information has been entered by the customer requesting information for a particular vehicle, providing a “sell” page (step 232). The sell page may include, inter alia, an option for the customer to log in to the report generation server 100 as a member or subscriber (see steps 258-262), to purchase a report, to enter a VIN, to view a sample report, and/or to obtain help locating a VIN on the vehicle.

In the instance a customer has identified a vehicle of interest, the VIN is entered into the partner website. If the VIN is not valid (step 234), a summary page is provided at step 236. The summary page may include, inter alia, an option for enabling the customer to log in to the report generation server as a member or subscriber (see steps 258-262), product description information, seller information, an option to purchase a report although no VIN is given, to view a sample report, and/or to obtain help locating the VIN on the vehicle. The product description information and the seller information comprise descriptive information, which, as discussed above, may be pooled from descriptive sources such as the partner website (originating from an advertisement selling the item) and/or other Internet sources.

The customer may purchase a VIN report although the entered VIN was not valid and, at step 238, a billing page is displayed. The billing page comprises the requisite credit card or other payment fields including billing address, billing name, credit card or bank account number, etc. Additionally, at the billing page, the descriptive information is displayed, as well as a summary of the report which is being purchased. Once a report is purchased, a confirmation page is displayed to the device 122 (step 240). The confirmation page confirms the purchase and provides information for obtaining the report.

If a valid VIN is entered at step 234, then per step 242, it is determined whether a report for the given VIN is available (see above). If a report is available, then per step 244 a summary page is displayed to the client device 122. The summary page of step 244 provides, inter alia, a log in option, a sample report, an option for the purchase of the report, and item description information. If the user selects to purchase the report, then as discussed above, a billing page is provided (step 246) and a confirmation page is displayed once the purchase is complete (step 250). The report itself is provided at step 248. In one embodiment, the report is sent to an email address associated with the purchaser. Alternatively it may be displayed within the partner web interface 128, or via a new interface.

If a report is not available per step 252, an unavailable page is displayed to the customer. The unavailable page provides, inter alia, a message indicating the unavailability, an option for the customer to sign in to the reporting server 100, a sample report, and/or an option to purchase a report. As discussed above, if a report is to be purchased, a purchase page is displayed (step 254) and confirmation is displayed upon validation of the billing information entered at the purchase page (step 256).

As noted above, the customer may be given an opportunity to sign into the reporting server 100. If the client is a returning customer (step 258), a login page is provided at step 260. The login page enables the customer to enter log in information as well as a VIN and receive the requested vehicle report (step 262).

### Exemplary Interfaces—

Referring now to FIGS. 3a-3g, various exemplary interfaces for display to customers on the client devices 122 via the partner website 128 are illustrated. These should in no way be considered limiting, but rather are merely examples of interfaces that may be used consistent with the invention.

FIG. 3a illustrates an exemplary interface 300 for enabling a consumer to obtain an item information report. As shown, the interface 300 generally comprises a partner identifier 302, which identifies the partner website. For example, the partner website may be eBay Motors®, CycleTrader®, AutoTrader®, CarMax®, etc. The interface 300 further includes a reporting service identifier 304, which identifies the service such as the InstaVin® of assignee hereof. When a customer selects an item to view, the description of the item is displayed in the seller description box 308. Details regarding the item including year, make, model, location, type and mileage, may be populated into a uniform display as shown. A customer is able to enter a VIN (or other identifier) at the box 306, or alternatively, the VIN may automatically populate when a user selects an item of interest.

The interface 300 of FIG. 3a further displays a sample report 310. The sample report 310 displays a vehicle description summary 316, an estimated value 312, and various vehicle details 314. The vehicle details 314 may include vehicle specifications, junk salvage/total loss information, title information, odometer information, etc. The interface 300 further displays a message box 218 for displaying messages regarding a report for the item or vehicle of interest to the customer.

FIG. 3b illustrates an exemplary interface 320 for displaying to a customer the availability of an item information report. As shown, at this interface 320, the customer may simultaneously view the sales description 308 while entering the VIN (at box 206) for query at the reporting server. As shown at the message box 218, a report for the particular VIN is available. Thus, the message box 218 also incorporates a feature to enable the customer to purchase the report 222. The interface 320 further includes the sales description 308 having photos and other details of the vehicle of interest. The previously discussed descriptive information sources 116 may be used to populate the sales description 308 section, or other sources may be used.

FIG. 3c illustrates an exemplary interface 330 for displaying to a customer the unavailability of an item information report. The interface 330 shows in the message box 218 a message indicating that data for the vehicle associated with the entered VIN is not available. An option to purchase a report is given at feature 334. Likewise, a message 332 is displayed to the customer to enter a second or different VIN. The interface 330 further includes the sales description 308. As discussed elsewhere herein, the description 308 displays photos and other details of the vehicle of interest and is populated with information obtained from the previously discussed descriptive information sources 116, or yet other sources.

FIG. 3d illustrates an exemplary interface 340 for enabling a customer to obtain an item information report without a VIN (or other identifying information). A message 342 is displayed to the customer indicating that they may purchase the report without a VIN. Additionally, the interface 340 of FIG. 3d illustrates an instruction message 344. The instruction message 344 displays information which enables the customer to discover the VIN if he/she cannot find it. As shown, the message may be pre-populated with information from the seller's advertisement of the vehicle indicating contact information for the seller, so that the customer may contact him/her directly to obtain the VIN. As with the previous interfaces, the interface 340 of FIG. 3d utilizes information from descriptive information sources 116 to simultaneously provide a sales description 308, or yet other sources.

FIG. 3e illustrates an interface 350 for enabling a customer to enter billing information for the purchase of an item information report. As shown the interface comprises a billing information entry segment 354 having a plurality of fields 356. The fields enable the customer to enter the number of reports requested, a billing name, address, card number, etc. Although not illustrated, the billing information page 350 may further display the descriptive information as illustrated in previous interface embodiments. Additionally, the interface 350 provides instructions for advance report purchases 352. As indicated, a customer may purchase a report prior to identifying a vehicle (such as by VIN) to which the report will relate, in other words, the customer may pre-pay for a report and provide a VIN at a later date/time.

The interface 360 of FIG. 3f enables a customer to validate an item information report before a purchase thereof. As shown, prior to confirming a purchase, VIN decode information may be displayed to the customer. The VIN decode information may be a summary of the information obtained by the report generating server 100 when the item quality information sources 114 and/or the descriptive information sources 116 are queried. The simultaneous display of descriptive information may also be provided at the interface 360 of FIG. 3f as discussed above.

The display of the VIN decode information simultaneous with the sellers vehicle description (including photos, descriptive information, and/or VIN) enables the customer to validate that the VIN and description listed in the advertisement matches the description pulled for that VIN from item quality sources (including e.g., vehicle history server and government data providers). In this manner, the customer may directly compare the vehicle identification so as to correct or avoid any misleading or fraudulent claims regarding the make model year and odometer readings between the verified government records and the advertisement, without having to leave the order process (i.e., on a single page). Still further, the customer may compare historical pictures, VIN decode, odometer reading and whether the vehicle is being sold by individual or dealer to stored advertisements and information. The comparison provides the added benefit of verification of odometer roll back, title washing, fraud, and verification of current sellers description of the vehicle, its condition or history. Suppose for example that a seller describes a vehicle as having never been painted, yet in a historical photo the car is a different color. The customer may therefore identify the seller as untrustworthy and thus may refuse to buy from him/her.

The interface 370 of FIG. 3g provides additional information to a customer regarding information provided in an item information report. As shown, the seller description 208 indicating descriptive information about the item for sale is displayed. As shown, when the user scrolls over the sample report section, a general description 272 of what is provided in the reports is displayed to the user.

### Error Checking Functions

The various embodiments of the invention described herein may also be configured with an ambiguity resolution system or algorithm. For example, suppose a VIN is collected from a sales description or advertisement and populated into a VIN entry box for submission to the reporting server 100 which is one or more digits off from the actual number. This could cause the system to return an erroneous report (or none at all), thereby wasting precious time for the user. Accordingly, several mechanisms can be used to mitigate this circumstance. In one variant, the error checking functions comprise cross-referencing the entered (or automatically detected) VIN against one or more additional (descriptive) pieces of information about the vehicle. For instance, along with the VIN, the pooling application 104 running on the server 100 might also pull information describing the vehicle as an Aston Martin (referring to the manufacturer) and black (referring to the vehicle's color). An application running on the reporting server 100 matches these elements (which may be coded by numbers, letters, etc. which are derived from the user's “plain language” input) to those derived from the item quality information sources 114 obtained when the VIN for the vehicle is sent thereto, in effect cross-checking the VIN and additional data to be sure that these match up. If, for example, the VIN entered by the user is one digit off, it may return a different color vehicle, which would indicate an error in the VIN somewhere. In this way, the user will not be inadvertently “spoofed” by receiving a message from the server with information that ostensibly appears to be relevant, but in fact actually relates to a totally different vehicle.

### Item Information Reports Database

In another embodiment, completed reports including item quality information and descriptive information are stored at a database (not shown) in communication with the reporting server 100. The database is searchable by VIN as well as by item descriptions. In this manner, when a request is received for a report, the database may be queried to determine whether a report already exists and may be provided quickly. Still further, these records may be stored and retrieved upon future sales. In other words, a report generated for a sale of a vehicle from party A to party B, may be later used (such as to provide descriptive information and certain item quality information in a sale of the vehicle from party B to party C. The descriptive information and/or item quality information may be utilized to provide a baseline report, which may then be updated by subsequent information returned from the item quality information sources 114 and descriptive information sources 116.

### Inspection Information

In another embodiment, the reporting server 100 may also access an inspection information server (not shown) which is configured to provide 3^{rd} party item condition information such as, inter alia, whether there are/is scratches, dents, frame damage, etc. to a vehicle. Providing such information obviates the client having to access the vehicle's appearance from any provided photos and/or rely on the seller's description. Rather, the third party views the vehicle's appearance and actual physical characteristics in detail and reports relevant information to a database listed by VIN \which is accessed by the report generation application 102 of the reporting server 100, in much the same manner as the other item quality information servers 114 discussed above. Note that this inspection information may be different than or not contained in a CarFax or similar third-party report, the latter which may describe only if the car has had any major accidents (e.g., those reported to police or DMV), hail damage, flooding, etc., but not necessarily more minor every-day type current damage such as door dings, scratches, faded paint or interior, etc.

### Warranty Information

The systems and methods of the present invention may be further utilized in conjunction with one or more entities adapted to report the status of a warranty (or provide other warranty-related information) for one or more automobiles. For example, the warranty reporting entities may disclose that an automobile is still under a factory or third-party (aftermarket) warranty, remaining time and/or mileage on that warranty (as many auto warranties are structured as “lesser of X years or Y miles”), and/or whether an existing warranty may be extended. This information, similar to the information disclosed above, may be sent to a client device as a part of the reporting process via email, text message/SMS, and/or voice message.

In one embodiment, the user is also provided with data indicating the level of warranty service actually performed on the vehicle (if available). For example, a history of multiple non-routine service calls on a car may be indicative of a “lemon”, or one which has undergone significant mistreatment or damage.

In another embodiment, the user may further be given an opportunity to purchase an extended warranty or related (e.g., complementary) coverage, if available. The purchase may be routed through a separate server associated with a warranty vendor or multiple vendors, or routed through the service described above and then to a third party vendor. These vendors utilize information about the vehicle and the user to generate an extended warranty contract which is forwarded to the user (via email, regular mail, or other mode). For example, a warranty vendor may obtain information about the vehicle by utilizing the VIN and/or may gain information from the vehicle manufacturer or seller. This information is then forwarded to a call center which completes a warranty contract, or may generate an email to be sent to the registered email address associated with the user.

### Client Interface/Account Generation and Management

In one embodiment, a customer may register and generate an account with the reporting server 100. Registration and account generation may be coordinated through one or more Internet-based interfaces. Thus, a client may be able to set-up an account with the reporting server 100 via an Internet connection and a device capable of accessing the Internet (such as a PC, laptop computer, PDA, or other client device).

In order to establish an account (register or set-up), the client will navigate any standard Internet browser in order to access a website tied to the reporting server 100 (or a partner website). The website comprises at least one tool for demonstrating the capabilities of the reporting system as well as at least one tool for enabling clients to “sign up” for these services.

It is appreciated that a quick description of product and advertising slogans may be displayed on one or more pages of the website. Information regarding membership fees, service fees, and subscription levels may also be presented to clients via the web interface. A linked email address and/or questions/comments page may also be presented. The website presents the client with a policy and licensing agreement for use of the protected methods and apparatus of the reporting system with an option for the client to accept the terms thereof.

Actual registration (set-up) of an account comprises providing the reporting server 100 with a name, billing information and a log in identity and password associated with the client's client device (for accessing and utilizing the system) via the web-based interface.

### Preferences, Searching, and Recommendations

In another embodiment, the client may be provided with options to identify one or more item details describing an item which he or she will search for in the partner websites. Using this information, the system can prepopulate search fields in the partner database. Additionally, the system can automatically search its partner sites using this information. Still further the server 100 may further be utilized to recommend items to a user based on previously inquired into items. In other words the server 100 may search one or more partner websites based on information describing an item entered or retrieved by a client device directly at the reporting server 100 or at a partner website. A recommendation entity, similar to that discussed in previously incorporated, co-owned and co-pending U.S. patent application Ser. No. 12/500,513, may be used. As discussed therein, the recommendation entity may searches for and suggests other items for sale which are similar to the requested item. The recommendation entity may use one or more factors for broadening a search for auction items similar to a selected item. For example, the recommendation entity may “pad out” the model year of a vehicle to search for similar cars which may be older or newer than the selected car. The recommendation entity may further classify the item such as classifying the Toyota Camry as a 4-door or mid-sized sedan, etc. Various classification and padding schemes may be utilized consistent with the present invention.

The recommendation entity may also be adapted to utilize a set of parameters or preferences entered by a user. In a similar manner as that discussed above with respect to searching, a user may enter one or more criteria for recommendations. The recommendation parameters may be broader than specific options or features. For example, a user may be prompted to enter a model year range, or select more than one of a plurality of options (such as different models, manufacturers, or colors), or select from a category of vehicle types (such as SUV, sedan, sports, etc.).

### Other Business Considerations

Various other business-related aspects of present invention are now described in detail.

In one embodiment, access to the various ones of the above-described features of the reporting system are featured as part of one or more optional subscription plans.

For example, access to increased number of item quality information servers 114 may be charged at a premium over more basic information servers. Thus, a first subscription plan may offer access to only one vehicle history server, while another plan may offer access to more than one and/or to more renowned vehicle history servers (charged at a higher premium to the client).

In another example, a client may develop a personalized set of information servers each server addition increasing the rate for the service.

In another example, a user may be offered different reporting levels at different price ranges. For example, access to a full report (such as one containing all information about a vehicle from every information server) may be offered at a higher premium than access to a partial report (such as one comprising short messages generally summarizing information from one or all of the information servers). Still further, a user may be given an option to receive both a full report and a partial report.

It is also appreciated that the aforementioned services may be offered on per item inquired into (such as per automobile). Alternatively, a user may purchase a subscription for access to the services on a multi-vehicle, per-month, and/or per-year basis.

Many other approaches and combinations are envisaged consistent with the invention, as will be recognized by those of ordinary skill when provided this disclosure.

It should be recognized that while the foregoing discussion of the various aspects of the invention has described specific sequences of steps necessary to perform the methods of the present invention, other sequences of steps may be used depending on the particular application. Specifically, additional steps may be added, and other steps deleted as being optional. Furthermore, the order of performance of certain steps may be permuted, and/or performed in parallel with other steps. Hence, the specific methods disclosed herein are merely exemplary of the broader methods of the invention.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The described embodiments are to be considered in all respects only illustrative and not restrictive. The scope of the invention is, therefore, indicated by the appended claims rather than the foregoing description. All changes that come within the meaning and range of equivalence of the claims are to embraced within their scope.

What is claimed is:

1. An apparatus for compiling information regarding an item for sale, comprising:
at least one interface configured to receive information uniquely identifying said item for sale; and
a digital processor configured to run at least one of:
(i) at least one application configured to use said uniquely identifying information to request item quality information from one or more trusted sources and create an item quality report therefrom;
(ii) at least one application configured to use said uniquely identifying information to request item description information from one or more descriptive information sources; and/or
(iii) at least one application configured to generate an advertisement relating to said item quality report, said advertisement incorporating said item description information.

2. The apparatus of claim 1, wherein the digital processor configured to run at least one is configured to run at least two of said (i)-(iii).

3. The apparatus of claim 1, wherein the digital processor configured to run at least one is configured to run at least all three of said (i)-(iii).
